(19) United States
(12) Patent Application Publication
(10) Pub. No.: US 2002/0167648 A1
(43) Pub. Date: Nov. 14, 2002

(54) Device for producing microfiche and method for producing a microfiche with such device

(76) Inventors: Josef Kickartz, Kirchheim/Teck (DE); Rolf Linnemann, Weilheim/Teck (DE)

Correspondence Address: GUDRUN E. HUCKETT, LONSSTR. 53, WUPPERTAL, 42289, DE

(21) Appl. No.: 09/852,456

(22) Filed: May 9, 2001

(51) Int. Cl. G02B 21/36

(52) U.S. Cl. 353/39

(57) ABSTRACT

A microfiche device for producing microfiche has a light source emitting a light beam for exposing during an exposure time a microfilm based on a data stream supplied to the light source by a computer. During exposure, a relative rotational or linear movement between the light beam and the microfilm is carried out. In order to generate the data stream, documents to be stored on microfiche are digitalized. The microfilm is exposed with the light beam line by line length-wise or width-wise for generating images of different sizes and formats on the microfilm.

### BACKGROUND OF THE INVENTION

1. Field of the Invention

The invention relates to a microfiche device for manufacturing microfiche, the device comprising a light source, preferably a laser unit, whose light beam exposes the microfilm as a function of a data stream supplied to the light source by a computer. The invention further relates to a method for producing a microfiche in such a microfiche device wherein the documents to be stored in the form of microfiche are digitalized and a light beam is controlled based on the data stream for exposure of the microfilm.

2. Description of the Related Art

For producing microfiche, the documents to be microfilmed and stored on microfiche are first digitalized, for example, by scanning, and are stored on a data storage device in a digital format. There are also situations in which these documents are already available in digitalized form. The data are supplied online or offline to the microfiche device. The microfiche device comprises a computer to which the data are supplied. In a special device, the data are converted to current values with which the optical unit is controlled such that the documents are produced as images on the microfiche. Only certain format sizes can be reproduced on microfiche. However, in practice it is possible that the documents to be microfilmed and stored on microfiche have different formats. It is then only possible with the known microfiche devices to reduce the larger formats to the smaller format acceptable for microfiche. However, image information is lost in this way.

With the prior art microfiche device exposure of the microfilm is carried out in a columnar fashion, i.e., the microfilm is exposed to formats that are positioned above one another within a column. As soon as the lower end of the column has been reached, the microfilm is moved by means of a worm gear by a travel stroke that corresponds to the next column width and returned into the initial position so that the next column of the microfiche can be again exposed with the optical unit from the top to the bottom. Such a method is time-consuming and results in a corresponding high wear of the microfiche device.

### SUMMARY OF THE INVENTION

It is an object of the present invention to develop a microfiche device and a method according to the aforementioned kind such that microfilming can be carried out within the shortest possible period of time with minimal stress and without image information for differently sized documents being lost on the microfiche.

In accordance with the present invention, this is achieved in regard to the microfiche device in that a relative rotation about an axis takes place during exposure between the microfilm and the light beam used for exposure of the microfilm.

According to another configuration of the microfiche device according to the invention, this object is achieved in that the light source is linearly movable relative to the portion of the microfilm to be exposed.

In accordance with the present invention, this object is achieved in regard to the method in that the microfilm for generating images is exposed line by line over its length or width.

In the microfiche device according to the invention a relative rotation is carried out during exposure between the optical unit and the microfilm. The laser beam impinging on the microfilm is thus moved along a circular arc. A complex adjusting device is not required in order to realize the relative rotation, so that the microfiche device according to the invention is of a constructively simple embodiment. The exposure of the microfilm can be realized image-wise, i.e., page-wise, but also line by line.

In an alternative embodiment of the present invention, the light source is linearly moved relative to the microfilm. This movability requires only a simple drive.

In the method according to the invention, the microfilm is exposed line by line across its length or width for generating the images. The exposure of the microfilm is thus realized pixel by pixel. This makes it possible to apply the images in any desired format on the microfiche. It is thus possible to store on the microfiche different image formats, in particular, also strip-shaped image formats which extend over the entire length or width of the microfiche. When large-format documents are microfilmed, they must not be reduced in size to the preset small image format of the microfiche. Instead, the image format can be selected freely on the microfiche so that the large-format documents can be applied as a correspondingly large-format image onto the microfiche. Accordingly, no image information is lost during microfilming.

### BRIEF DESCRIPTION OF THE DRAWING

In the drawing:

FIG. 1 is a schematic side view illustration of the microfiche device according to the invention for producing microfiche;

FIG. 2 is an end view of the microfiche device according to FIG. 1;

FIG. 3 is a schematic illustration of a guide of the microfilm in the microfiche device according to the invention;

FIG. 4 is a schematic illustration of a switching device for the microfiche device according to the invention;

FIG. 5 shows a block diagram of the conversion of individual images into a pixel stream for producing the microfiche;

FIG. 6 is a schematic illustration of the conversion of pixels of different individual images into pixel streams containing these individual images;

FIG. 7 shows a pattern arranged on the microfiche which has been produced in a conventional microfiche device according to known methods;

FIG. 8 shows a pattern arranged on the microfiche which has been produced in a conventional microfiche device according to known methods;

FIG. 9 shows a first example for a pattern of division of microfiche which is produced with the microfiche device according to the invention according to the method according to the invention;

FIG. 10 shows a second example for a pattern of division of microfiche which is produced with the microfiche device according to the invention according to the method according to the invention;

FIG. 11 shows a third example for a pattern of division of microfiche which is produced with the microfiche device according to the invention according to the method according to the invention;

FIG. 12 is a schematic illustration of a second configuration of a microfiche device according to the invention;

FIG. 13 is a schematic illustration of a plan view onto a microfilm curved about its longitudinal axis;

FIG. 14 shows the microfilm according to FIG. 13 in a perspective illustration;

FIG. 15 shows a third configuration of a microfiche device according to the invention in a schematic illustration;

FIG. 16 shows a laser head of the microfiche device according to the invention of FIG. 15; and

FIG. 17 shows in a schematic illustration a further embodiment of the microfiche device according to the invention.

### DESCRIPTION OF THE PREFERRED EMBODIMENTS

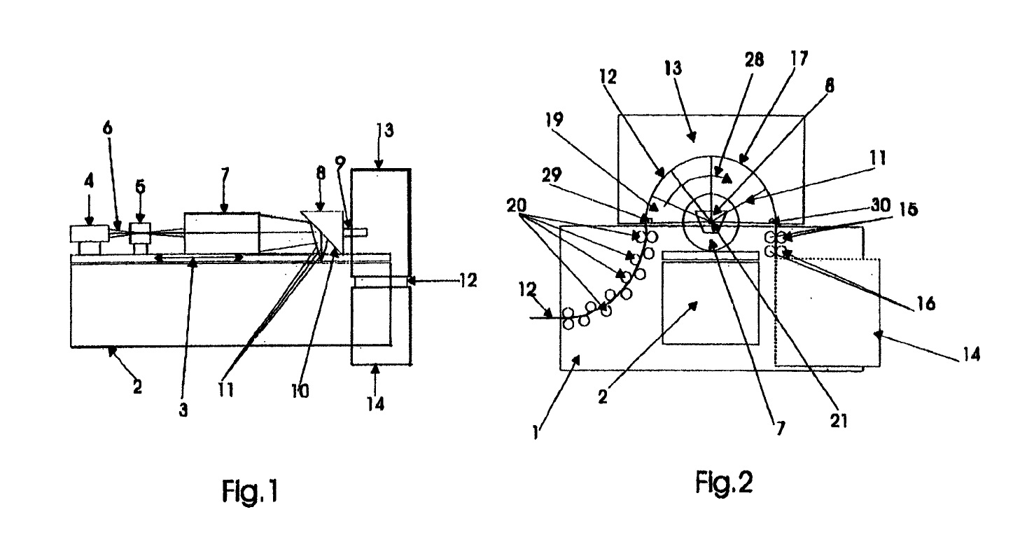

With a microfiche device to be described in the following, a microfiche can be produced quickly, simply, and inexpensively with high resolution and excellent sharpness. The microfiche device according to FIGS. 1 and 2 has a frame 1 for a linear unit 2 which is movable in the direction of the double arrow 3. On the linear unit 2 (carnage or slide) a laser unit 4 is arranged which is, for example, a helium-neon laser but can also be any other suitable laser. When, for example, only black and white documents are used for microfilming, the laser unit 4 can be a UV laser. This has the advantage that a microfilm of polymer synthetic material can be used that does not contain silver halogenides. Accordingly, during the production of the microfiche the complex and expensive developing process and the correlated environmental problems are eliminated. If it is desired to also microfilm color documents, on the linear unit 4 advantageously three lasers operating additively are used which generate, based on the three primary colors red, green, and blue, all colors as a function of the selected color.

An acoustic-optical modulator 5 (AOM) is arranged downstream of the laser unit 4 on the linear unit 2. The laser beam 6 which is emitted by the laser unit 4 passes through the modulator 5 in a manner to be described in the following and reaches an optical device comprising a telescope unit 7 and an optical unit 8 which are both also arranged on the linear unit 2. The telescope unit 7 ensures that the laser beam 6 coming from the modulator 5 is first widened upon entering and then again refocused when exiting. The converging light beams exiting from the telescope unit 7 impinge on the optical unit 8 which is rotatable (spinning unit). The optical unit 8 can also be a polygon member with a corresponding number of reflective surfaces. The optical unit 8 is seated on a horizontal shaft 9 which extends in the movement direction 3 of the linear unit 2. The optical unit 8 is rotatably driven by the shaft 9. The optical unit 8 with the shaft 9 and the drive (not illustrated) are seated also on linear unit 2. The optical unit 8 has a reflective surface 10 extending at a slant to the direction of the beam on which the beams coming from the telescope unit 7 are totally reflected. The relative arrangement of the telescope unit 7 and optical unit 8 as well as the position of the reflective surface 10 are adjusted to one another such that the beams 11 reflected at the reflective surface 10 are focused onto the microfilm 12. In order to eliminate possibly occurring stray light caused by the reflective surface, a slotted diaphragm is advantageously provided in the path of the beam. It ensures that only the main beam will reach the microfilm 12 while the stray light is decoupled.

The linear unit 2 is moved by a suitable drive (not illustrated) along the frame 1 in the movement direction 3 relative to a microfilm drum 13. The drive for the linear unit 2 can be of any suitable configuration. In particular, it must be of a low friction design and must be movable with high precision in order to expose the microfilm 12 perfectly and precisely.

In the illustrated embodiment, the microfilm drum 13 is stationarily arranged so that the linear unit 2 is moved relative to the microfilm drum 13 for exposure of the microfilm 12. It is also possible to design the microfilm drum 13 so as to be movable. Then the laser unit 4, the modulator 5, the telescope unit 7, and the optical unit 8 can be stationarily arranged in the movement direction. Finally, it is also possible to move the linear unit 2 as well as the microfilm drum 13 during exposure of the microfilm 12 in a direction toward one another.

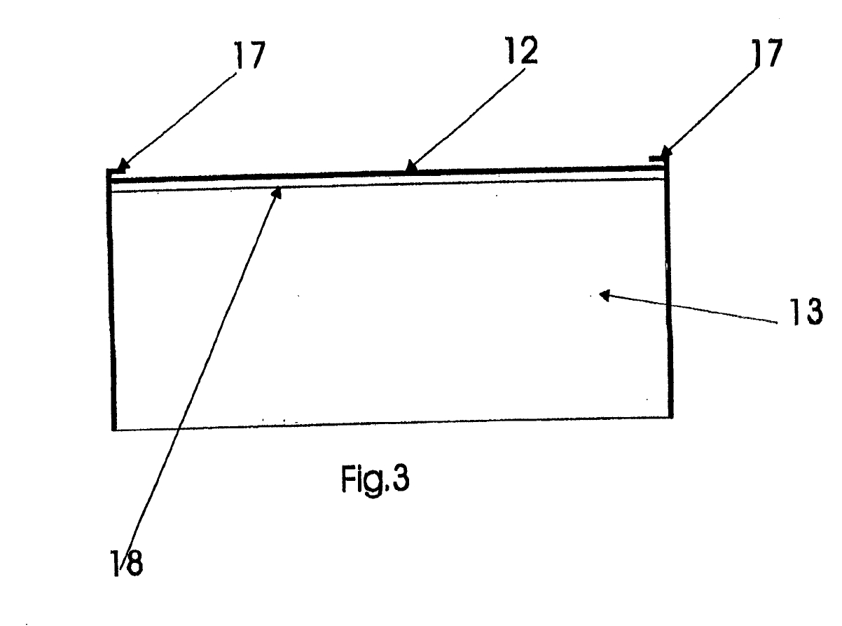

The microfilm 12 to be exposed is arranged in a microfilm cassette 14 which is secured, for example, on the sidewall of the frame 1. The microfilm 12 is guided through at least one roller pair, in the embodiment through two roller pairs 15 and 16, before entering the microfilm drum 13. At least one roller pair is rotatably driven. The microfilm 12 is guided on the roller pairs 15, 16 to the microfilm drum 13. the microfilm drum 13 has a passage way 19 with a semi-cylindrical support (inner wall) 18. A guide 17 is provided on the inner wall 18 of the semi-cylindrical passageway 19 extending through the microfilm drum 13. As illustrated in FIG. 3, the longitudinal edges of the microfilm 12 to be exposed are guided along the corresponding guides 17 which are formed as stays or rails facing one another and having a minimal spacing from the inner wall 18 of the passageway 19. The guides 17 and/or the inner wall 18 in the area of the guides 17 can be provided with a friction-reducing coating in order to ensure a problem-free transport of the microfilm 12 through the microfilm drum 13.

After exiting from the microfilm drum 13, the microfilm 12 reaches the area between several rollers or rolls 20 which are supported on the frame 1. At least one roller pair 20 is rotatably driven. The rollers 20 are arranged along a curved path (FIG. 2) so that the exposed microfilm 12 can be guided without problem to a developing or processing unit (not illustrated). In the developing/processing unit, the microfilm 12 exposed in the microfilm drum 13 is developed in the way known in the art.

The axis 21 (FIG. 2) of the inner wall 18 coincides with the axis of the shaft 9 of the optical unit 8. This ensures that the microfilm 12 is positioned within the passageway 19 on a mantle of the cylinder whose axis is the axis 21. When the optical unit 8 is embodied as a polygon member, these two axes are slightly staggered relative to one another. The spacing of the staggered arrangement is so minimal that it can be easily compensated by simple corrective measures, for example, by enlarging the focal length.

During the exposure to be described in the following, the microfilm 12 is not moved within the microfilm drum 13. In order to ensure a proper positional securing of the microfilm 12 during exposure, it is pulled advantageously by vacuum against the inner wall 18. For this purpose, the inner wall 18 is provided with openings (not illustrated) which are connected to a corresponding vacuum source, for example, a vacuum pump. This vacuum is adjusted such that the portion of the microfilm 12 to be exposed is non-slidably secured on the inner wall 18 of the microfilm drum 13 during exposure.

After completion of exposure, the microfilm 12 is transported farther. In order to prevent the microfilm 12 from becoming scratched, it is advantageously lifted off the inner wall 18 of the microfilm drum 13 by compressed air so that it will not contact the inner wall 18 during the further transport. The lateral rail-shaped guides 17 serve as stops for the microfilm 12 so that it will not lift in an uncontrolled fashion off the inner wall 18 when applying the compressed air, but is secured along its longitudinal edges by the guides 17. As soon as the next portion of the microfilm 12 to be exposed is positioned within the passageway 19 of the microfilm drum 13, the supply of compressed air is switched off and vacuum or suction air will pull the portion of the microfilm 12 to be exposed securely against the inner wall 18 in the above described manner.

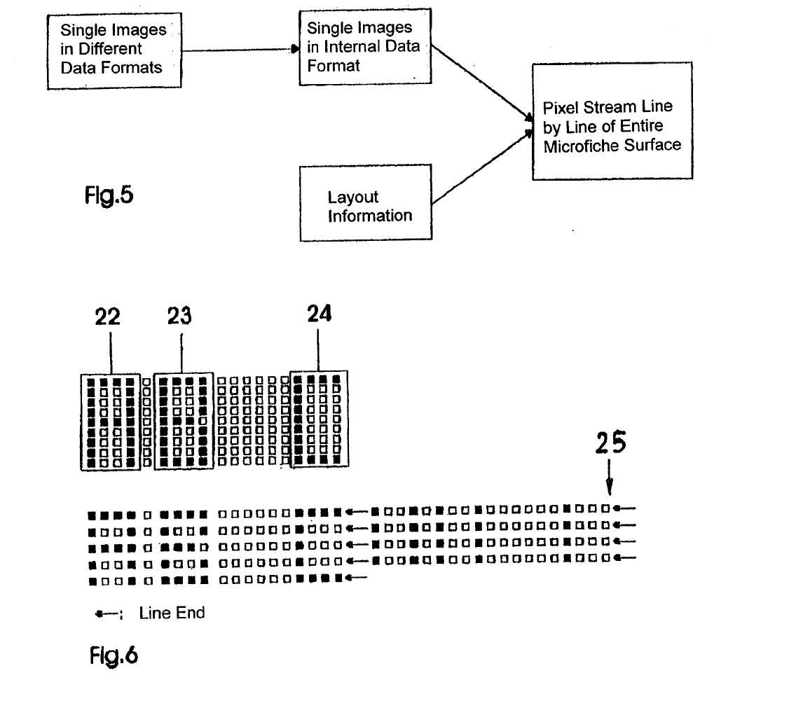

The documents to be microfilmed are first digitalized. For this purpose, the used documents can be, for example, scanned by a scanner and then stored on data storage devices or data carriers in the form of individual files. According to the number of the documents to be microfilmed, a corresponding number of files is stored on the data storage member. As can be taken from the block diagram according to FIG. 5, these individual images can be present in different data formats, depending on the type of the digitalization process that has been performed. The data are subsequently, if this is necessary, converted into a data format that is readable by the microfiche device. The accordingly converted data are then converted together with layout information to a pixel stream so that there are no longer individual files but a single file is present which is employed by the microfiche device for exposure of the microfilm 12. The layout information contains data, for example, in regard to the number of lines and columns of the images to be applied, about the size of the images, intermediate spaces and the like. The user himself can thus define the layout of the surface of the microfiche 12. Space markers for the images are positioned on the microfiche surface. The space markers can be freely positioned. The images of the documents to be microfilmed having any possible different size are inserted preferably so as to be centered between the space markers. Of course, the microfiche 12 can also be provided with a conventional pattern.

In general, the conversion of the files themselves and the conversion into a pixel stream are carried out by the user of the microfiche device. However, it is also possible that such conversions are carried out directly by the company or person placing the microfiche order, insofar as the company or person has the corresponding software. It is also possible that the documents to be microfilmed are digitalized by the user of the microfiche device, the resulting files are optionally format-converted, and then conversion into the pixel stream is carried.

FIG. 6 shows as an example three documents 22 to 24 which are to be microfilmed. The document 22 contains the letter A, the document 23 the letter B, and the document 24 the letter C. These three documents 22 to 24 are first digitalized and then stored, respectively, in the form of a file on a data storage device. These three files are then, as has been discussed above in connection with FIG. 5, converted, if necessary, into the data format which is required for further processing in the described microfiche device. Inasmuch as already during digitalization of the documents 22 to 24 the correct data format for the microfiche device has been used, the file format conversion can, of course, be eliminated. Subsequently, the files are combined to a single file in which the digitalized files are combined to a continuous pixel stream 25.

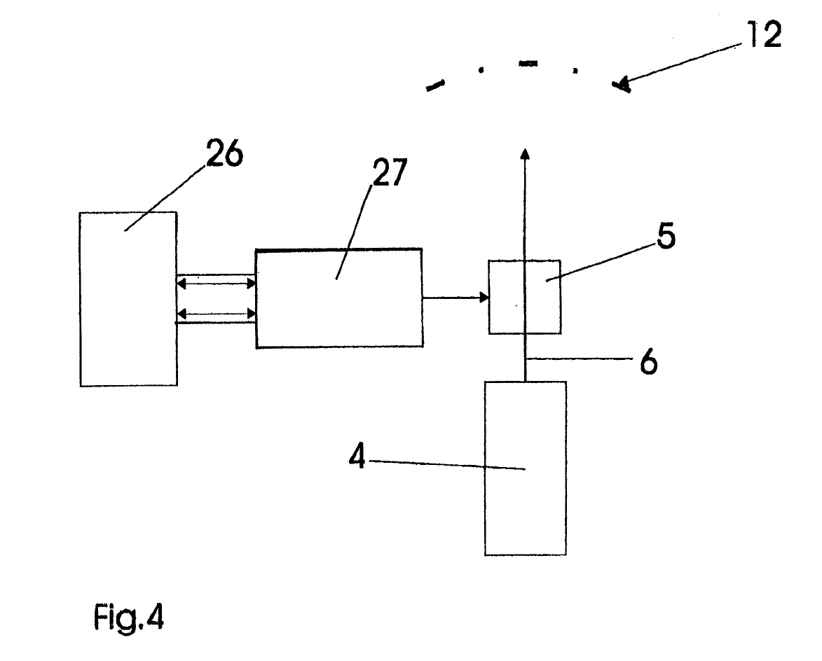

The microfiche device is provided either with an integrated computer 26 or an external computer 26 by which the pixel streams 25 stored on the data storage device are supplied to the microfiche device. The computer 26 has arranged downstream thereof a digital-analog converter 27 (FIG. 4) which converts the digital input signals coming from the computer 26 into analog voltage signals. They are supplied to the electronic device of the acoustic optical modulator 5 which is positioned in the path of the beam of the laser unit 4. In FIG. 4, a dash-dotted line in the area of the microfilm drum 13 illustrates the microfilm 12 to be exposed. The microfilm 12 is exposed by means of the modulator 5 as a function of the converted pixel stream 25.

The microfiche device is designed such that the microfilm 12 is exposed by means of the reflective beam 11 line by line. At the beginning of the microfilm exposure, the linear unit 2 is moved relative to the microfilm drum 13 such that the beams reflected by the optical unit 8 impinge on the leading end of the microfilm 12. The microfilm 12 is first preferably threaded fully automatically into the microfilm drum 13 so that it rests over the entire length to be exposed on the inner wall 18 of the passageway 19 of the microfilm drum 13. The portion of the microfilm 12 resting against the inner wall 18 is exposed line by line over its length. For this purpose, the optical unit 8 is rotatably driven by means of the shaft 9 about the horizontal axis 21. The rotational direction of the optical unit 8 is indicated in FIG. 2 with 28. At the beginning of the exposure cycle, the optical unit 8 has such a starting position that the reflected beam 11 first is located external to the passageway 19. While the optical unit 8 is still external to the passageway 19, it is driven already with full rotational speed. The computer at this point does not yet supply the data streams for the exposure of the microfilm 12. The linear unit 2 is moved with the preset speed in the direction toward the microfilm drum 13. As soon as the optical unit 8 has reached a preset spacing from the leading end of the microfilm 12 positioned in the passageway 19, the computer 26 receives a signal so that the data stream 25 required for exposing the microfilm is now supplied by the computer 26. In doing so, it is achieved that at the point in time at which the laser beam 11 impinges on the leading end of the microfilm 12, the beginning of the data stream 25 is already available. In order to determine the described position of the linear unit 2 shortly before the microfilm drum 13, the microfiche device is provided with a corresponding sensor unit (not illustrated) which sends the corresponding signal to the computer 26 for starting the data/pixel stream 25. Such a sensor unit can be, for example, a light barrier. It is also possible to determine the position of the linear unit 2 by the drive control itself and to send a corresponding signal to the computer 26 when a preset position has been reached. At the location where the beam 11 enters the passageway 19, at least one sensor 29 of a synchronization device is provided onto which the reflected beam 11 impinges upon entering the microfilm drum 13. Upon rotation of the optical unit 8 in the direction 28, the microfilm 12 within the microfilm drum 13 is exposed along a line in the longitudinal direction. At the other end of the passageway 19 at least one further sensor 30 is provided onto which the beam 11 will impinge upon exiting from the passageway 19. The second sensor 30 is connected to a control (not illustrated) which upon further rotation of the optical unit 8 in the direction 28, for example, will switch off the laser unit 4 or will reduce its power. This is advantageous because the reflected laser beam 11 outside of the passageway 19 cannot impinge on the microfilm 12 so that the full power of the laser unit is not required in this area. It is, of course, possible to set the laser unit 4 during the entire 360° rotation of the optical unit 8 to full radiation power.

As soon as the reflected beam impinges again on the sensor 29 at the beginning of exposure, the laser unit 4, in the case that its power had been reduced or in the case that it had been switched off, is again reset to the required power for exposure. Moreover, the computer 26 is triggered by the sensor 29 to release the next data/pixel stream 25 for exposure of the next line of the microfilm 12.

The described synchronization device is not required when it is possible to determine, based only on the rotational speed and the rotational travel of the optical unit 8, at what point in time the reflected laser beam 11 impinges on the microfilm 12.

The rotational movement of the optical unit 8 is synchronized with the computer 26 such that the pixel streams are provided by the computer only when the reflected laser beam 11 impinges on the microfilm 12. The supply of pixel streams 25 is thus realized as a function of the rotational speed and the rotational stroke of the optical unit 8. By means of the described control, the data pixel stream 25 from the computer 26 to the modulator 5 can thus be controlled.

During exposure of the microfilm 12 the linear unit 2 is continuously moved relative to the microfilm drum 13 wherein the microfilm 12 is exposed line by line across its length or width. However, it is also possible to move the linear unit 2 step-by-step in the direction toward the microfilm drum 13. As soon as one line has been exposed on the microfilm 12, the linear unit 2 is moved in this case so far against the microfilm drum 13 that during the subsequent rotation of the optical unit 8 the next line of the microfilm 12 is exposed. In this way, the area of the microfilm 12 positioned in the microfilm drum 13 is exposed over its width line by line.

After exposure, the microfilm 12 is fully automatically pulled out of the microfilm cassette 14 so that the previously exposed portion of the microfilm is pulled out of the microfilm drum 13 and a microfilm portion not yet exposed is now within the passageway 19 of the microfilm drum 13. In the manner described above, this microfilm portion is now exposed line by line.

Since the optical unit 8 is rotatably driven about the axis 21 and the portion of the microfilm to be exposed rests on a cylinder mantle about the axis 21, a uniform sharpness and excellent resolution, in particular, on the edge areas of the microfilm can be obtained over the entire width of the microfilm 12. During exposure, the optical unit 8 rotates advantageously at constant rotational speed. The optical unit 8 has, for example, during the exposure a rotational speed of 200 revolutions per second so that the exposure of a conventional microfilm requires only approximately 90 seconds. The rotational speed is selected such that the microfilm 12 is optimally exposed. It is, in principle, possible to increase the rotational speed of the optical unit 8 when the reflected laser beam 11 has passed the sensor 30 and is positioned underneath the passageway 19. In this case, the exposure time of the next line can be shortened.

The axial movability of the linear unit 2 is adjusted to the rotational speed of the optical unit 8 so that the microfilm 12 is exposed line by line to the desired degree.

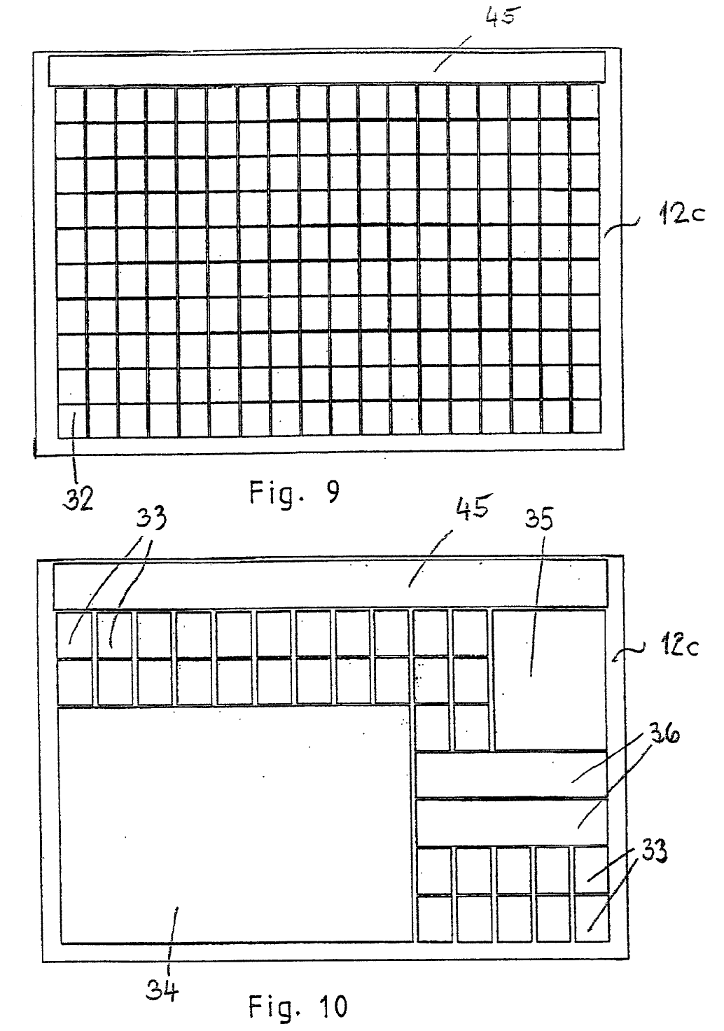

Even though the microfilm 12 is exposed line by line, individual images arranged in patterns are produced on the microfilm 12 as will be explained in the following in connection with FIGS. 9 to 11. The line by line exposure of the microfilm has the advantage that different formats in different arrangements can be provided on the microfilm 12.

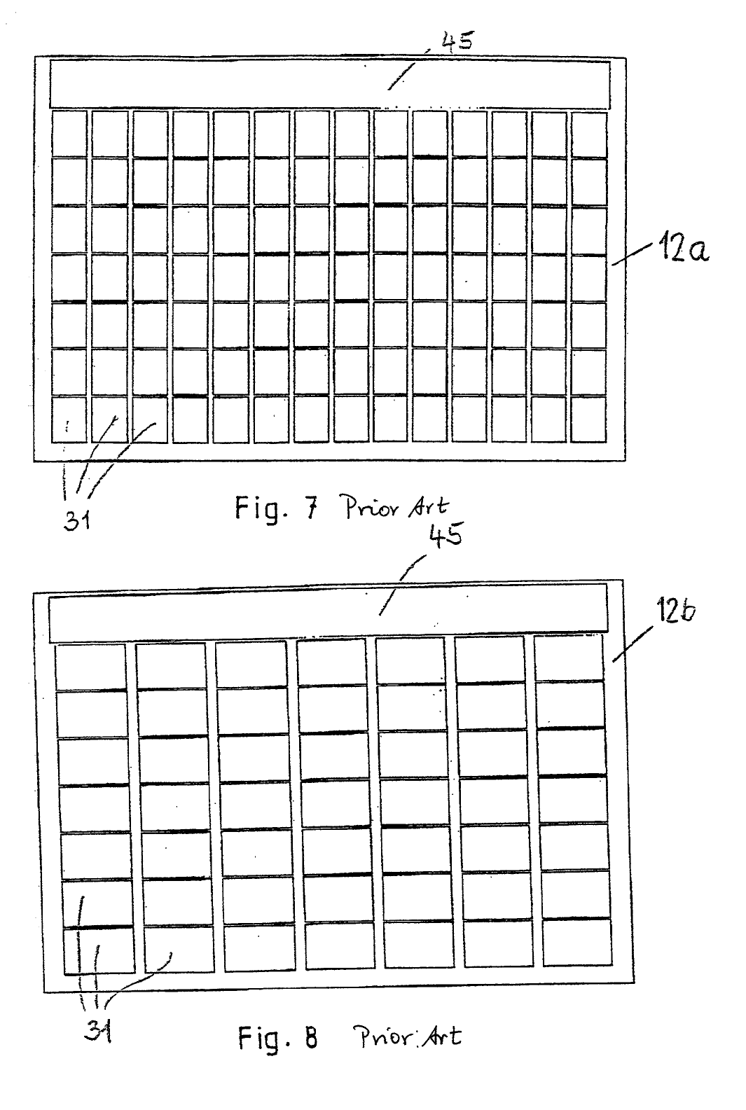

FIGS. 7 and 8 show microfiche 12a, 12b produced according to known methods. Only certain format sizes can be applied on the microfiche 12a, 12b. According to FIG. 7, the individual images 31 are arranged in portrait format in rows and columns. All images 31 have the same format. According to FIG. 8 the images 31 have landscape format and are also arranged in rows and columns. The individual images 31 have also the same format. However, in practice it may occur that the documents to be microfilmed have different formats. With the known microfiche devices it is then only possible to reduce the larger format to the format corresponding to image 31. However, this reduces the image information because the large image format must be decreased in size in order to fit within the format of the image 31.

With the described microfiche device according to the invention, images of most different formats can be arranged on the microfiche 12c as desired. FIG. 9 shows the simple case where the microfiche images 32 are arranged in rows and columns. The images 32 have the same format.

FIG. 10 shows that the images on the microfiche 12c have very different formats. In this connection, the images 33 have the same format. They are arranged in rows and columns. In addition to these images 33, the microfiche has an image 34 that is substantially larger than the image 33. In contrast to the known microfiche, this large-format image 34 is not converted to the format of the smaller images 33. Accordingly, the image information of image 34 remains completely intact.

The microfiche 12c contains, for example, the image 35 which, in contrast to the image 34, is not in landscape format but in portrait format and is substantially larger than the images 33, but smaller than the image 34. Finally, same size elongate images 36 which have strip format are arranged on the microfilm 12.

This embodiment shows that by means of the described microfiche device according to the invention most different image formats can be arranged on the microfiche 12c. This microfiche 12 has been exposed across its length line by line according to the data of the pixel stream 25, and, by doing so, the individual images 33 to 36 of different sizes have been produced on the microfiche. The information generating these different images 33 to 36 is stored as a continuous pixel stream 25 in a corresponding file on the data storage device or data carrier.

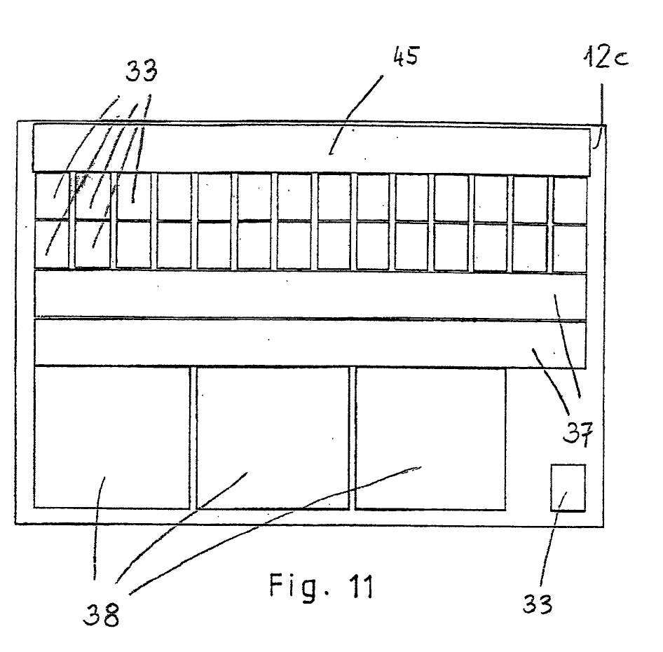

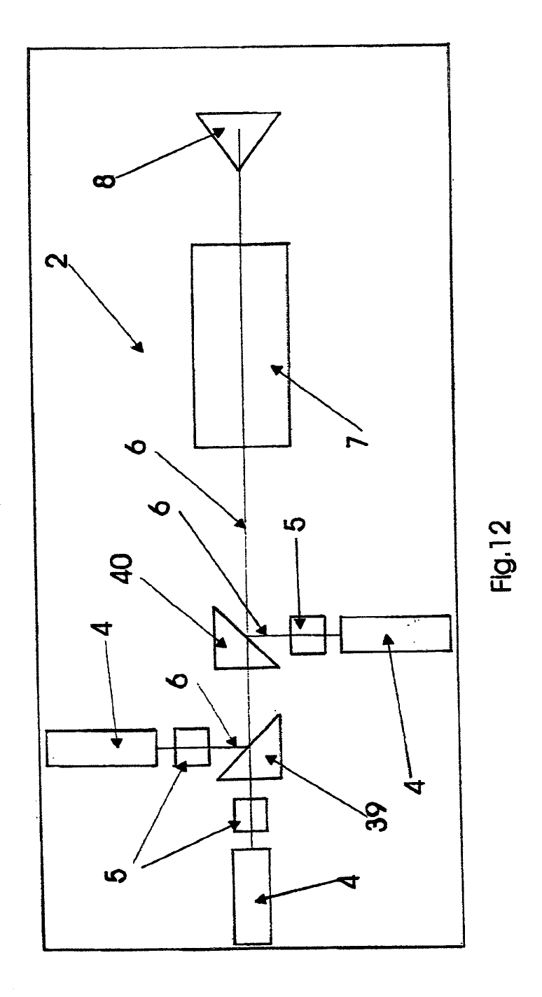

FIG. 11 shows a further possibility in regard to how to arrange the individual differently sized images on the microfiche 12c. It has images 33 arranged in two rows. Underneath these image rows, two strip-shaped images 37 are arranged which extend also across the width of the microfilm and have the same length as the rows of images 33 above. Underneath the two images 37, large-format images 38 are provided which are of the same size and arranged successively in a row. Moreover, in the right lower corner a single image 33 is arranged. This embodiment also illustrates that images of different sizes can be arranged on the microfiche 12c. Accordingly, it is possible to store large-format images with their correspondingly large size on the microfiche 12c so that the information contents of these large-size images is not lost. In particular, strip-shaped images 36, 37 can be arranged on the microfiche 12c which has not been possible in conventional microfilming. Accordingly, the field of application for such microfiche is greater. For example, in hospitals or in doctors's offices EKG recordings can be microfilmed in such a way that no information is lost in the microfilm images.

The microfilm 12 is advantageously unwound from a film spool. After the afore described exposure in the microfilm drum 13, the microfilm 12 is then separated after, or advantageously before, developing so that individual microfiche 12 result. However, it is also possible to use individual microfilm sheets instead of an endless film supply which sheets have already the required format for microfiche. In this case, the microfilm sheets are individually exposed in the described way within the microfilm drum 13.

In order to ensure a high color tone separation, the microfiche device operates preferably with a resolution of up to 8 bit. Accordingly, this makes it possible to measure continuous tone values without having to carry out rasterization which would result in a reduction of the image quality. As a result of the high color tone separation, images can be produced that are very true to the original even when the original documents have a different number of gray tints.

In order to be able to produce also color microfilm, the microfiche device can be provided with three laser units 4 (FIG. 12) which operate additively and which produce the desired colors based on the primary colors red, green, and blue as a function of the selected color. These three laser units 4 are also arranged on the linear unit 2. Each laser unit 4 has correlated therewith an acoustic optical modulator 5 which, as described above (FIG. 4), are arranged downstream of a digital-analog voltage converter 27, as has been explained in connection with the preceding embodiment. One laser unit 4 is positioned in the axial orientation of the telescope unit 7 while the other two laser units 4 are positioned at a right angle thereto. For this reason, the beams 6 emitted by the laser units 4 are reflected at dividing mirrors 39, 40 such that the beams emitted by the three laser units 4 are focused into the telescope unit 7. The optical unit 8 is arranged downstream of the telescope unit and, as in previous embodiment, is advantageously embodied so as to be rotatable (spinning unit) but can also be in the form of a polygon member. The telescope unit 7 in connection with the spinning unit 8 generates as a function of the data/pixel stream 25 the desired color shade. The exposure of the microfilm 12 is carried out in the same way as has been explained in detail in connection with the previous embodiment.

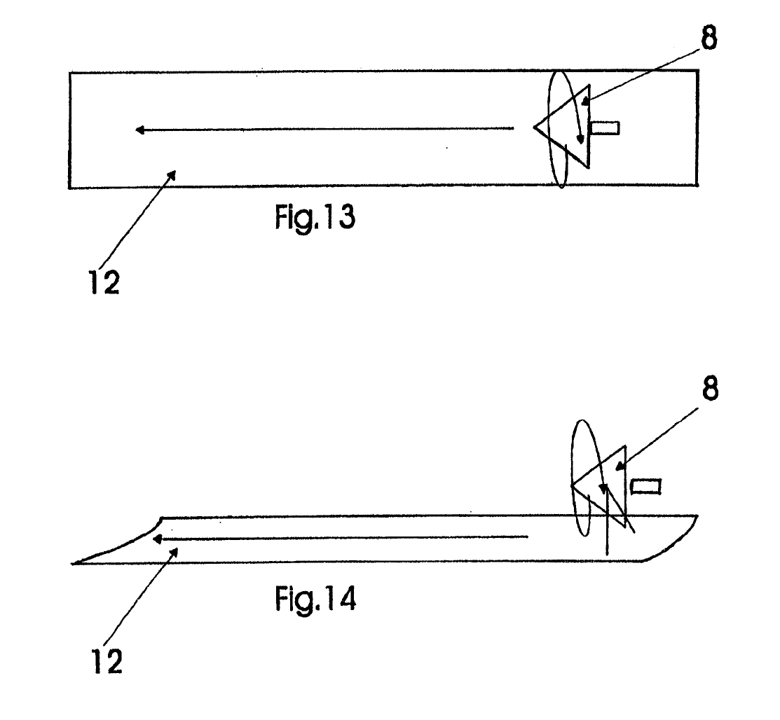

FIGS. 13 and 14 show the possibility to curve the microfilm 12 not across its length, as illustrated in the embodiment according to FIGS. 1 and 2, but across its width. While in the embodiment according to FIGS. 1 and 2, the axis of curvature 21 is perpendicular to the longitudinal axis of the microfilm 12, the axis of curvature in the embodiment according to FIGS. 13, 14 extends in the longitudinal direction of the microfilm 12. The inner wall 18 of the microfilm drum 13 is formed according to this curvature of the microfilm 12. The exposure of the microfilm 12 is carried out in the same way line by line across the width of the microfilm 12.

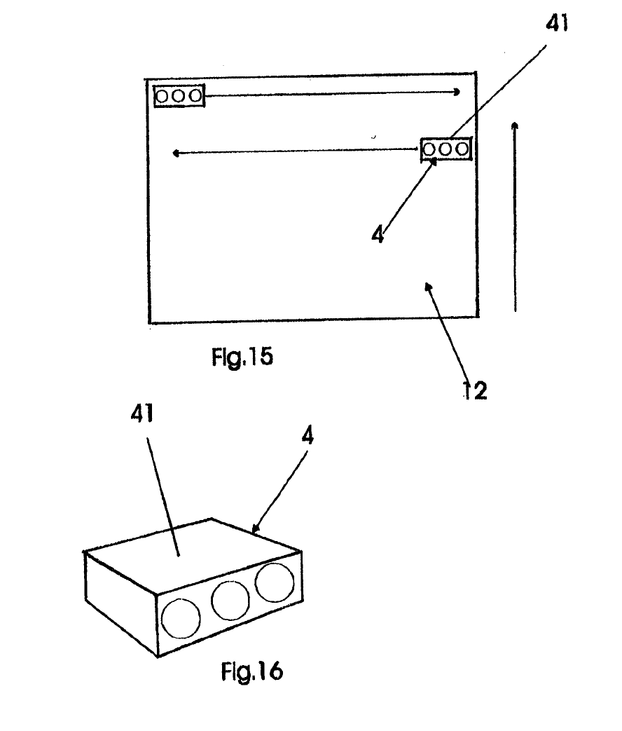

FIGS. 15 and 16 show as an example that laser diodes can be used as the laser unit 4. In the illustrated embodiment, three laser diodes in the primary colors red, green, and blue are provided which are arranged in a laser head 41. The laser head 41 is linearly moved back and forth on a linear guide (not illustrated), and the microfilm 12 to be exposed is passed underneath it in a direction depending on the movement direction of the laser head 41. The microfilm 12 can be again used in the form of endless microfilm or as individual microfilm sheets. In this embodiment, an optical device is not required between the laser unit 4 and the microfilm 12. The beams emitted by the laser diodes are directly focused onto the microfilm 12. In such an embodiment, the microfilm 12 is also exposed line by line across its width or length as has been explained in detail in connection with the first embodiment. In order to obtain short exposure times, the line by line exposure of the microfilm 12 is carried out in both movement directions of the laser head 41. The data/pixel stream 25 is supplied by the computer 26 according to the movement direction.

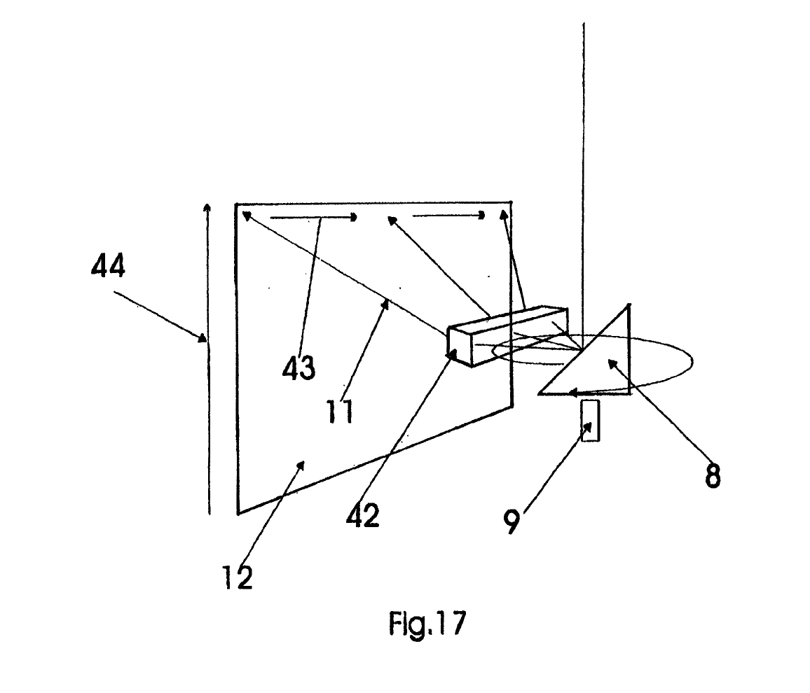

FIG. 17 shows finally an embodiment in which the light reflected by the optical unit 8 is guided through a cylinder lens 42. It ensures that the reflected laser beam 11 is deflected by the required amount and focused. The optical unit 8 is rotated by the shaft 9 in the manner described above so that the laser beams 11 penetrating the cylinder lens 42 are moved line by line in the direction of arrow 43 on the microfilm 12. In this embodiment, the microfilm 12 is also exposed line by line as has been explained in detail supra. During exposure, the microfilm 12 moves as a function of the rotational speed of the optical unit 8 in the direction of arrow 44 so that the microfilm 12 is exposed across its width line by line. It is also possible to arrange the microfilm 12 stationarily and to then move the optical unit 8 with the cylinder lens 42 relative to the microfilm 12. It is finally also possible to move the microfilm 12 as well as the optical unit 8 with the cylinder lens 42 in opposite directions.

In this embodiment, it is also possible to use a polygon member as an optical unit 8 instead of the spinning unit.

The microfilm drum 13 with the linear unit 2 and the frame 1 are, of course, arranged in a light-tight enclosure which is not illustrated in the drawings.

Instead of the described laser units 4, other suitable light sources can be used for the exposure of the microfilm 12, for example, incandescent lamps, such as xenon lamps. The microfilm 12 can also be exposed line by line as a function of the data/pixel stream 25 with such light sources.

The light source or the laser unit 4 must not be arranged on the linear unit 2. In such cases, the light is supplied directly through a light guide to the modulator 5.

In the embodiment according to FIGS. 1 and 2, the portion of the microfilm 12 resting against the inner wall 18 of the passageway 19 of the microfilm drum 13 is so long that two microfiche can be produced from this exposed microfilm portion. It is thus possible to apply simultaneously different data to these microfiche during exposure so that, after exposure and separation of the exposed microfilm, two separate microfiche with completely different contents will be obtained.

As illustrated in FIGS. 7 to 11, each microfiche 12 is provided with a title field 45. Since with the known microfiche devices, the microfiche can be exposed only page by page, only individual image blocks can be arranged adjacent to one another in this title field 45. With the described microfiche device according to the invention, on the other hand, the entire width and/or height of the title field can be continuously provided with a corresponding title or the like because the microfilm 12 is not exposed page by page but line by line across its length or width.

While specific embodiments of the invention have been shown and described in detail to illustrate the inventive principles, it will be understood that the invention may be embodied otherwise without departing from such principles.

What is claimed is:

1. A microfiche device for producing microfiche, said microfiche device comprising:
a light source (4) configured to emit a light beam (6, 11) for exposing during an exposure time a microfilm (12) based on a data stream supplied to said light source (4) by a computer;
means for carrying out a relative rotational movement between said light beam (11) and the microfilm (12) during said exposure time.

2. The microfiche device according to claim 1, wherein a portion of the microfilm (12) to be exposed by said light beam (11) is curved about a rotational axis (21) about which said rotational movement is carried out.

3. The microfiche device according to claim 2, further comprising at least one optical device (7, 8) positioned between said light source (4) and the microfilm such that said light beam (11) is guided through said at least one optical device (7, 8) to the microfilm (12).

4. The microfiche device according to claim 3, wherein said at least one optical device (7, 8) comprises a telescope unit (7).

5. The microfiche device according to claim 3, wherein said at least one optical device (7, 8) has an optical unit (8) rotatable about said rotational axis (21).

6. The microfiche device according to claim 5, further comprising a shaft (9) on which said optical unit (7, 8) is seated.

7. The microfiche device according to claim 5, wherein said optical unit (8) is configured to be moveable relative to the microfilm (12)

8. The microfiche device according to claim 5, comprising a microfilm drum (13) wherein the portion of the microfilm (12) to be exposed is positioned in said microfilm drum (13).

9. The microfiche device according to claim 8, wherein said microfilm drum (13) has a curved support (18) configured to support the portion of the microfilm (12) to be exposed.

10. The microfiche device according to claim 8, wherein said microfilm drum (13) has a passage way (19) and wherein said optical unit (8) is positioned at least partially in said passageway (19) during said exposure time.

11. The microfiche device according to claim 9, wherein said support (18) is curved about said rotational axis (21).

12. The microfiche device according to claim 11, wherein the microfilm (12) has a longitudinal extension in a direction of said rotational axis (12).

13. The microfiche device according to claim 11, wherein the microfilm (12) has a longitudinal extension in a direction transverse to said rotational axis (12).

14. The microfiche device according to claim 5, wherein said optical unit (8) has at least one reflective surface (10) configured to reflect said light beam (11) toward the microfilm (12).

15. The microfiche device according to claim 14, wherein said optical unit (8) is a spinning unit.

16. The microfiche device according to claim 14, wherein said optical unit (8) is a polygon member.

17. The microfiche device according to claim 5, further comprising at least one carriage (2), wherein said optical unit (8) is arranged on said at least one carriage (2).

18. The microfiche device according to claim 17, wherein said at least one carriage (2) is moveable in a direction of said rotational axis (21).

19. The microfiche device according to claim 17, wherein said light source (4) is arranged on said at least one carriage (2).

20. The microfiche device according to claim 5, further comprising a light guide configured to guide said light beam (6) emitted by said light source (4) to said optical device (7, 8).

21. The microfiche device according to claim 8, wherein said microfilm drum (13) is configured to be moveable relative to said optical device (7, 8).

22. The microfiche device according to claim 14, wherein said optical unit (8) is configured to be rotatably driven at a constant rotational speed at least within the range in which said light beam (11) reflected on said reflective surface (10) impinges on the microfilm (12).

23. The microfiche device according to claim 1, further comprising at least one modulator (5) arranged downstream of said light source (4) in a path of said light beam (6).

24. The microfiche device according to claim 23, further comprising at least one digital-analog converter (27) connected to said at least one modulator (5).

25. The microfiche device according to claim 23, wherein said at least one modulator (5) modulates said light beam (6) based on said data stream (25).

26. The microfiche device according to claim 9, wherein said support (18) has a guide (17) for the microfilm (12).

27. The microfiche device according to claim 9, wherein said guide (17) is configured to guide the portion of the microfilm (12) to be exposed laterally therethrough.

28. The microfiche device according to claim 9, wherein said support (18) is configured to pull the portion of the microfilm (12) to be exposed against said support (18) by applying a vacuum.

29. The microfiche device according to claim 28, wherein said support (18) is configured to release the portion of the microfilm (12) after exposure for further transport of the microfilm (12).

30. The microfiche device according to claim 5, further comprising at least one synchronizing unit (29) configured to synchronize the supply of said data stream (25) with at least one of the rotational speed and the rotational travel of said optical unit (8).

31. The microfiche device according to claim 30, wherein said at least one synchronizing unit (29) has at least one sensor (29) positioned in the path of said light beam (11) shortly before a leading end of the portion of the microfilm (12) to be exposed.

32. A microfiche device for producing microfiche, said microfiche device comprising:
a light source (4) configured to emit a light beam (6, 11) for exposing during an exposure time a microfilm (12) based on a data stream supplied to said light source (4) by a computer, wherein said light source (4) is configured to be linearly moveably relative to the portion of the microfilm (12) to be exposed.

33. The microfiche device according to claim 32, wherein said light source (4) is configured to be linearly moveable across the entire width and length of the portion of the microfilm (12) to be exposed.

34. The microfiche device according to claim 32, wherein said light source (4) is a laser comprising a laser head (41) with laser diodes.

35. A method for producing a microfiche in a microfiche device having a light source (4) configured to emit a light beam (6, 11) for exposing during an exposure time a microfilm (12) based on a data stream supplied to said light source (4) by a computer, said method comprising the steps of:
digitalizing documents to be stored on microfiche to form a data stream;
controlling a light beam (11) emitted by a light source (4) for exposing during an exposure time a microfilm (12) based on the data stream;
exposing the microfilm (12) with the light beam (11) line by line lengthwise or width-wise for generating images on the microfilm (12).

36. The method according to claim 35, wherein, in the step of exposing, a relative movement of the light beam (11) and the microfilm (12) is carried out after each line of exposure.

37. The method according to claim 35, wherein, in the step of exposing, a relative movement of the light beam (11) and the microfilm (12) is carried out continuously during exposure.

38. The method according to claim 35, comprising the steps of storing the data resulting from the step of digitalizing on a data storage device and combining the data in the form of a data-pixel stream (25).

39. The method according to claim 38, further comprising the step of supplying the data-pixel stream (25) to a modulator (5) of the microfiche device.

40. The method according to claim 39, wherein the modulator (5) modulates the light beam (11) based on the data-pixel stream (25).

41. The method according to claim 39, wherein the data-pixel stream (25) is supplied as a function of at least one of the rotational speed and the rotational travel of an optical unit (8) of the microfiche device.

42. The method according to claim 41, further comprising the step of rotating the optical unit (8) at a constant speed.

43. The method according to claim 35, further comprising the step of at least reducing the output of the light source (4) when the light beam (11) does not impinge on the microfilm (12).
